(19) United States
(12) Patent Application Publication
(10) Pub. No.: US 2008/0072715 A1
(43) Pub. Date: Mar. 27, 2008

(54) Ratchet type bending spanner

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 11/523,821

(22) Filed: Sep. 19, 2006

(51) Int. Cl. B25B 13/46

(52) U.S. Cl. 81/60

(57) ABSTRACT

A ratchet type bent spanner comprises a handle; a holding portion at one end of the handle; a bent tubular portion at another end of the handle; an engaging unit having a part rotatable installed in the bent tubular portion; and the other part of the engaging unit being protruded from the bent tubular portion for engaging with a sleeve; the part in the bent tubular portion being formed with a ratchet portion which is engaged to a buckling block; and the buckling block being restorable elastically. A switch is installed in the bent tubular portion for controlling the shift of a position of the engaging block so as to form a bidirectional ratchet type bent spanner. The handle is a soft handle with a stop edge.

### FIELD OF THE INVENTION

The present invention relates to spanner, and particularly to a ratchet type bent spanner, in that the user is unnecessary to perform the complicated operation of taking out and restoring the bent tubular spanner and then engaging the nut. Thus the driver can replace a tire easily and quickly. Furthermore, the ratchet type bent spanner can be designed as a unidirectional or bidirectional devices.

### BACKGROUND OF THE INVENTION

In locking or unlocking the screws of the car tires, a bent spanner is used. This is because the screws are recessed in the recess of a tire. Thus the straight spanner can not be used since the spanner 1 will has a side adhere to the tire rim and thus it can not be operated effectively.

A bent tube spanner has a bent portion and a head of the bent portion has a rectangular post for engaging with a sleeve. Then the sleeve will enter into the recess of the tire rim for engaging with a screw.

When a tire is exploded, a jack is used to lift the tire upwards to leave from the ground with a distance. The elevation of the car from the ground is limited. Generally the bent spanner is very long. The limitation is not sufficient for a bent spanner to drive a screw of the tire effectively. As a result, the spanner only rotates through a very finite range, such as one half or one third of a turn before the hand of the operator contact the ground. Thus the spanner 1 must return and then the operation is repeated. As a result, the operation is tedious and is not effective.

### SUMMARY OF THE INVENTION

Accordingly, the primary object of the present invention is to provide a ratchet type bent spanner, in that the user is not unnecessary to perform the complicated operation of taking out and restoring the bent tubular spanner and then engaging the nut. Thus the driver can replace a tire easily and quickly. Furthermore, the ratchet type bent spanner can be designed as a unidirectional or a bidirectional device.

To achieve above objects, the present invention provides A ratchet type bent spanner comprising: a hollow handle having a holding portion at one end thereof; a front end of the holding portion having a stop edge; another end of the handle having a bent tubular portion; a rotatable engaging unit being installed with a part being within the bent tubular portion; and other part of the engaging unit protruding from the bent tubular portion; the engaging unit being a stepped tube; the protruded engaging unit being formed with a rectangular post so that the engaging unit can be engaged with sleeves of different sizes; one surface of the rectangular post being formed with a recess for receiving a buckling unit which can be formed by a spring and a steel ball; thus the rectangular post can be firmly secured with a sleeve; a ratchet portion being hidden in the bent tubular portion and being connected to the engaging unit; an engaging block being engageable with the ratchet portion ; one surface of the engaging block having teeth for engaging to the ratchet portion and another surface of the engaging block being resisted with an inner wall of the bent tubular portion with an elastic unit; the elastic unit being illustrated between the another surface and the inner wall.

The various objects and advantages of the present invention will be more readily understood from the following detailed description when read in conjunction with the appended drawing.

### BRIEF DESCRIPTION OF THE DRAWINGS

FIG. 1 is a partial cross sectional view of the ratchet type bent spanner of the. present invention.

FIG. 1A is a perspective view about the tube portion of the ratchet type bent spanner of the present invention.

FIG. 2 is a schematic cross sectional view of the bent tubular portion of the ratchet type bent spanner of the present invention.

FIG. 3 is a cross sectional view along line A-A of FIG. 2.

FIG. 4 is a schematic view showing the operation of the ratchet type bent spanner of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

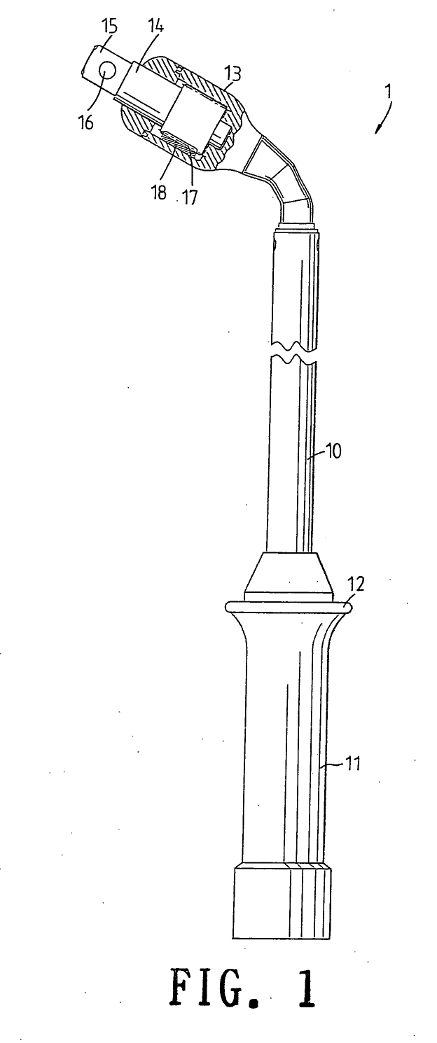

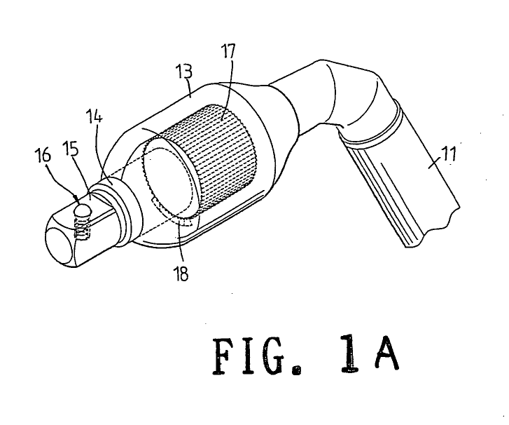

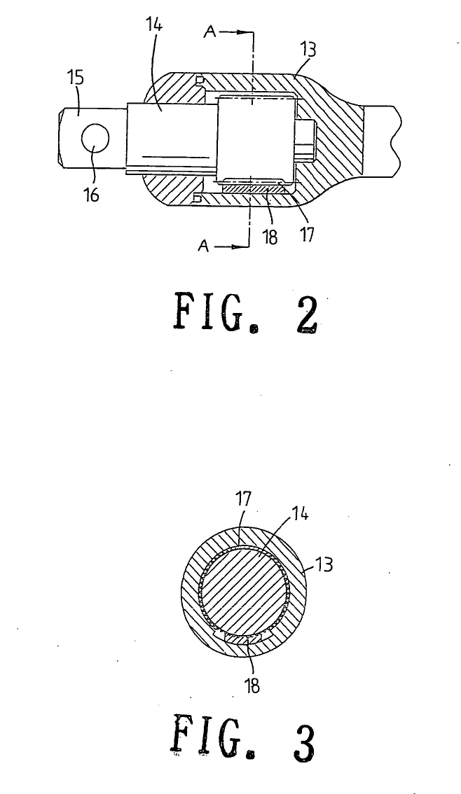

With referring to FIGS. 1 to 3, the ratchet bent tube spanner of the present invention is illustrated. The spanner 1 of the present invention has the following elements.

A hollow handle 10 has a holding portion 11 at one end thereof. A front end of the holding portion 11 has a stop edge 12. Another end of the handle 10 has a bent tubular portion 13. A rotatable engaging unit 14 is installed with a part being within the bent tubular portion 13. Other part of the engaging unit 14 protrudes from the bent tubular portion 13. The engaging unit 14 is a stepped tube. The protruded engaging unit 14 is formed with a rectangular post 15 so that the engaging unit 14 can be engaged with sleeves 30 of different sizes. Referring to FIG. 1, one surface of the rectangular post 15 is formed with a recess for receiving a buckling unit 16 which can be formed by a spring and a steel ball. Thus the rectangular post 15 can be firmly secured with a sleeve 30. A ratchet portion 17 is hidden in the bent tubular portion 13 and is connected to the engaging unit 14. An engaging block 18 is engageable with the ratchet portion 17. One surface of the engaging block 18 has teeth for engaging to the ratchet portion 17 and another surface of the engaging block 18 is resisted with an inner wall of the bent tubular portion 13 with an elastic unit (not shown) between the another surface and the inner wall.

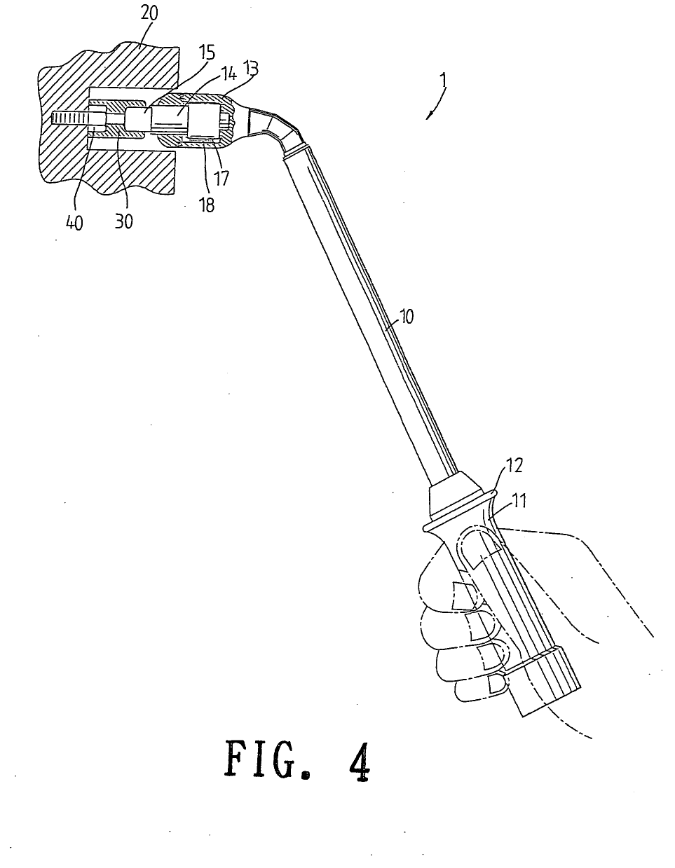

Referring to FIG. 4, the use of the present invention will be described herein.

When the present invention is used to detach a tire 20, a sleeve 30 sleeves 30 a proper section of the protruding portion of the engaging unit 14 so that a nut 40 can be locked or detached easily. The ratchet portion 17 in the bent tubular portion 13 can rotate reciprocally. When the handle 10 rotates to be resisted by an object (ground surface), it is only necessary to rotate the handle 10 along a reverse direction. Then the engaging block 18 will jump to another teeth so that the handle 10 can be used again. In the present invention, the ratchet portion 17 in the bent tubular portion 13 rotates unidirectional. It is unnecessary to perform the complicated operation of taking out and restoring the bent tubular spanner and then engaging the nut. Thus the driver can replace a tire easily and quickly.

Other than the unidirectional design illustrated in the drawing, the bent tubular portion 13 of the present invention can be installed with a switch at the bent tubular portion 13 so as to control the shift of the engaging block 18 in two direction and thus the present invention is formed as a bidirectional device for locking and unlocking a screw object.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1-3. (canceled)

4. A ratchet type bent spanner comprising:
a hollow handle having a holding portion at one end thereof; a front end of the holding portion 11 having a stop edge; another end of the handle having a bent tubular portion; the tubular portion having a hollow space;
a rotatable engaging unit being a stepped tube having three stepped parts; a larger part of the engaging unit being installed within the hollow space of the bent tubular portion; and other two parts of the engaging unit protruding from the bent tubular portion; a front most part of the protruded two parts of the engaging unit being a rectangular post so that the engaging unit can be engaged with sleeves of different sizes;
one surface of the rectangular post being formed with a recess for receiving a buckling unit which can be formed by a spring and a steel ball; thus the rectangular post can be firmly secured with a sleeve;
a ratchet portion being hidden in the bent tubular portion and being connected to the engaging unit;
an engaging block being engageable with the ratchet portion; one surface of the engaging block 18 having teeth for engaging to the ratchet portion and another. surface of the engaging block 18 being resisted with an inner wall of the bent tubular portion with an elastic unit; the elastic unit being installed between the another surface and the inner wall.
